(19) United States
(12) Patent Application Publication
(10) Pub. No.: US 2008/0227909 A1
(43) Pub. Date: Sep. 18, 2008

(54) Method for Producing Thermally Conductive Sheet and Thermally Conductive Sheet Produced by the Method

(76) Inventors: Masaki Yoda, Sagamihara-shi (JP); Yoshinao Yamazaki, Yokohama-city (JP)

Correspondence Address: 3M INNOVATIVE PROPERTIES COMPANY, PO BOX 33427, ST. PAUL, MN, 55133-3427, US

(21) Appl. No.: 12/090,309

(22) PCT Filed: Oct. 27, 2006
(86) PCT No.: PCT/US06/42104

§ 371 Date: Apr. 15, 2008

(30) Foreign Application Priority Data
Oct. 28, 2005 (JP) 2005-315107

(51) Int. Cl. B29C 35/08; C08L 33/04

(52) U.S. Cl. 524/560; 264/494

(57) ABSTRACT

Provided is a method for producing a thermally conductive sheet, comprising shaping a thermally conductive precursor composition into a sheet, the thermally conductive precursor composition comprising a (meth)acrylic monomer or a polymerizable oligomer thereof, a photopolymerization initiator, and a thermally conductive filler present in an amount of 20 vol % or more based on the total volume of the thermally conductive composition obtained, and irradiating the front surface and the back surface of the sheet with ultraviolet radiation at different ultraviolet irradiation intensities, thereby curing the sheet and obtaining a thermally conductive sheet having a single-layer thermally conductive composition and having tackiness differing between the front surface and the back surface.

### TECHNICAL FIELD

The present invention relates to a method for producing a thermally conductive sheet, and a thermally conductive sheet produced by the method.

### BACKGROUND ART

A thermally conductive sheet for dissipating heat is used in electronic components/electric devices such as a computer. As for types of thermally conductive sheets, there are thermally conductive sheets having tackiness on the surface thereof and thermally conductive sheets not having tackiness on the surface thereof. The thermally conductive sheet having tackiness is required, in view of handleability, to have reduced or no tackiness on one surface of the sheet as compared with the tackiness of the other surface, in other words, to have tackiness significantly differing between the front surface and the back surface of the sheet.

In order to meet this requirement, a thermally conductive sheet in which either a base material or beads are applied to one surface of the thermally conductive sheet has been proposed (see, for example, Japanese Unexamined Patent Publication (Kokai) Nos. 2001-168246 and 2003-133769, respectively). In this case, due to attachment of a base material or beads to the sheet, the process is complicated or the cost increases. Also, a powder material which is a blocking (adhesion) inhibitor may be used as an anti-blocking powder, but the blocking inhibitor may become a powder dust and adversely affects the electronic component. Moreover, equipment for applying the blocking inhibitor is necessary. Other than these, a thermally conductive sheet in which a pressure-sensitive adhesive layer or a non-tacky layer is provided on one surface of a previously produced sheet, or a multilayer thermally conductive sheet having tackiness differing between the front surface and the back surface, which is obtained by stacking a plurality of thermally conductive sheets differing in the tackiness property, is commercially available. However, the production of such a sheet also requires an extra number of steps.

Furthermore, Japanese Unexamined Patent Publication (Kokai) Nos. 59-56471, 6-306336 and 8-151555, respectively) have proposed an acrylic pressure-sensitive adhesive double-coated tape in which the adhesive force differs between the front surface and the back surface. However, such a tape has a very low thermal conductivity and is not a thermally conductive tape.

### SUMMARY OF THE INVENTION

Accordingly, one object of the present invention is to provide a single-layer thermally conductive sheet having tackiness differing between the front surface and the back surface without requiring an additional step of removing surface tackiness, for example, by applying a base material, beads or an anti-blocking powder.

In one embodiment, the present invention provides a method for producing a thermally conductive sheet, comprising:

(a) shaping a thermally conductive sheet precursor composition into a sheet having a front surface and a back surface, the thermally conductive sheet precursor composition comprising a (meth)acrylic monomer or a polymerizable oligomer thereof, a photopolymerization initiator, and a thermally conductive filler present in an amount of 20 vol % or more based on the total volume of the thermally conductive composition obtained, and

(b) irradiating the front surface and the back surface of the sheet with ultraviolet radiation of different ultraviolet irradiation intensities such that the irradiation intensity on the surface irradiated at a higher intensity is 30 times, or less, than the irradiation intensity on the surface irradiated at a lower intensity, thereby curing the sheet and obtaining a thermally conductive sheet consisting of a single-layer thermally conductive composition and having tackiness differing between the front surface and the back surface.

According to the production method of the present invention, while the obtained thermally conductive sheet is a single layer, it has tackiness differing between the front surface and the back surface. Furthermore, one surface of the sheet can be made to have almost no tackiness by adjusting the ultraviolet intensity even without applying a film base material, an anti-blocking powder or the like to the one surface.

The production method of a thermally conductive sheet of the present invention is described below based on the best modes for carrying out the invention, but the present invention is not limited to the following embodiments and it should be understood that appropriate changes and modifications can be made therein according to the knowledge of one skilled in the art without departing from the scope of the present invention. Incidentally, the term “a (meth)acryl” as used herein means “an acryl or a methacryl”, and “a (meth)acrylic monomer” means “an acrylic monomer such as acrylic acid and acrylic ester, or a methacrylic monomer such as methacrylic acid and methacrylic ester”.

### Production Method of Acrylic Single-Layer Thermally Conductive Sheet

### Production Method 1:

The acrylic single-layer thermally conductive sheet of this embodiment is produced by shaping a thermally conductive sheet precursor composition into a sheet, the thermally conductive sheet precursor composition comprising a (meth)acrylic monomer or a polymerizable oligomer thereof, a photopolymerization initiator, and a thermally conductive filler present in an amount of 20 vol % or more based on the total volume of the thermally conductive composition obtained, and irradiating the front surface and the back surface of the sheet with ultraviolet radiation of different ultraviolet irradiation intensities, thereby curing the sheet and obtaining a thermally conductive sheet consisting of a single-layer thermally conductive composition and having tackiness differing between the front surface and the back surface. More specifically, in the production of the acrylic single-layer thermally conductive sheet of this embodiment, the thermally conductive composition comprising a monofunctional (meth)acrylic monomer, a photopolymerization initiator and a thermally conductive filler is degassed and mixed in a planetary mixer or the like, sandwiched between two liners and shaped into a sheet by calender molding or the like. Thereafter, each of the front and the back surfaces of the sheet, still holding liners, is irradiated with ultraviolet radiation at an intensity different from the other surface, whereby the sheet is polymerized (cured) and a thermally conductive sheet can be obtained. By irradiating ultraviolet radiation at different intensities on each of the surfaces of the sheet, the sheet-like shaped article can be polymerized and cured. Also, when the ultraviolet transmittance differs between liners on the front and back surfaces, the ultraviolet radiation can be irradiated at the same intensity on the front and back surfaces.

The irradiation of ultraviolet radiation can be performed by using a lamp emitting ultraviolet radiation at a wavelength of 400 nm or less. Examples of the lamp which can be used include a low-pressure mercury lamp, a medium-pressure mercury lamp, a high-pressure mercury lamp, an ultrahigh-pressure mercury lamp, a chemical lamp, a black light lamp, a microwave-excited mercury lamp and a metal halide lamp. On the side irradiated at a higher intensity, the ultraviolet radiation is preferably irradiated at an ultraviolet irradiation intensity of 0.2 to 1.5 mW/cm². The irradiation time is preferably from several seconds to about 30 minutes. If the ultraviolet irradiation intensity is too low, the polymerization reaction takes excessively long time and both surfaces tend to lose tackiness. On the other hand, if the ultraviolet irradiation is too high, the resulting sheet may have inadequate cohesive strength, and thus may not maintain its shape. The irradiation intensity on the surface irradiated at a higher intensity is 30 times or less, preferably from 2 to 20 times, the irradiation intensity on the surface irradiated at a lower intensity. If the irradiation intensity ratio is too small, a sufficiently large difference in the tack strength may not be obtained between the two surfaces, whereas if it is too large, polymerization proceeds only on one surface and the thermally conductive filler may migrate to the other surface to bring a powder-coated state.

The irradiation intensity may be adjusted by causing the ultraviolet irradiation intensities themselves to differ between respective surfaces or by changing the ultraviolet transmittance of the liners disposed on respective surfaces while setting the ultraviolet irradiation intensities themselves to be the same. Accordingly, in the case of shaping a thermally conductive composition precursor between two liners, when liners differing in the ultraviolet transmittance are used and the same ultraviolet radiation is irradiated from both liner sides, the present invention can be implemented.

### Monofunctional (Meth)Acrylic Monomer

The monofunctional (meth)acrylic monomer used for the thermally conductive sheet of this embodiment may be a monomer used for the formation of a general (meth)acrylic polymer, and is not particularly limited. These monofunctional (meth)acrylic monomers may be used individually or as a mixture of two or more thereof. Suitable examples thereof include a monofunctional (meth)acrylic monomer containing an alkyl group having a carbon number of 20 or less, and specific examples thereof include ethyl (meth)acrylate, butyl (meth)acrylate, hexyl (meth)acrylate, 2-ethylhexyl (meth)acrylate, octyl (meth)acrylate, isooctyl (meth)acrylate, decyl (meth)acrylate, dodecyl (meth)acrylate, acrylic acid, methacrylic acid, acrylamide and N,N-dimethylacrylamide.

The monofunctional (meth)acrylic monomer before any polymerization, generally has low viscosity and the handleability thereof is sometimes bad. In such a case, the thermally conductive filler may not be uniformly distributed throughout the thermally conductive sheet. Therefore, before shaping the thermally conductive composition precursor into a sheet, the monofunctional (meth)acrylic monomer is preferably converted into a polymerizable oligomer by partially polymerizing it in advance and increasing the viscosity. The partial polymerization is preferably performed until the viscosity becomes approximately from 5 to 10,000 mPa·s. The partial polymerization can be performed by various methods and specific examples thereof include thermal polymerization, ultraviolet polymerization, electron beam polymerization, γ-ray irradiation polymerization and ionizing beam irradiation polymerization. Incidentally, in order to perform the partial polymerization, an appropriate polymerization initiator can be added to the thermally conductive composition precursor.

### Photopolymerization Initiator

Examples of the photopolymerization initiator include benzoin ethers such as benzoin ethyl ether and benzoin isopropyl ether, an anisoin ethyl ether, an anisoin isopropyl ether, Michler's ketone (4,4′-tetramethyldiaminobenzophenone), and substituted acetophenones such as 2,2-dimethoxy-2-phenylacetophenone (e.g., KB-1 (trade name, produced by Sartomer Company), Irgacure 651 (trade name, produced by Ciba-Geigy Specialty-Chemicals)) and 2,2-diethoxyacetophenone. Other examples include substituted α-ketols such as 2-methyl-2-hydroxypropiophenone, and aromatic sulfonyl chlorides such as 2-naphthalenesulfonyl chloride. These photopolymerization initiators may be used individually or in an arbitrary combination. The amount of the polymerization initiator is not particularly limited but is usually from 0.1 to 2.0 parts by mass per 100 parts by mass of the monomer component.

### Thermally Conductive Filler

The thermally conductive filler is an essential component for causing the thermally conductive sheet to exert substantial thermal conductivity. Examples of the thermally conductive filler include a hydrous metal compound, a metal oxide, a metal nitride and a metal carbide. Sole compound or sole kind of compound may be used or a plurality of compounds or a plurality of kinds of compounds may be used in combination. In view of filling property and curing rate of sheet, a white-type filler such as aluminum hydroxide, magnesium hydroxide and alumina (aluminum oxide) is preferred. As for the amount filled, the thermally conductive filler is preferably filled to occupy from 20 to 80 vol % of the thermally conductive composition. If the amount filled is less than 20 vol %, the thermal conductivity of the composition decreases and the performance as the thermally conductive sheet is not satisfied. Furthermore, if the thermally conductive filler content is less than 20 vol %, the ultraviolet radiation is not scattered by the thermally conductive filler and tends to be transmitted from one surface to the other surface without yielding a decrease in the ultraviolet intensity and the effect of irradiating ultraviolet radiation at different irradiation intensities is not fully brought out. As a result, a sufficiently large difference is not obtained in the tackiness between the front and back sides of the sheet and the handleability decreases. On the other hand, if the thermally conductive filler content exceeds 80 vol %, the sheet becomes hard, exhibits poor adhesion to a heat-generating element, and fails in satisfactorily fulfilling its heat-conducting function. Examples of the hydrous metal compound include barium hydroxide and calcium hydroxide in addition to the above-described aluminum hydroxide and magnesium hydroxide. Examples of the metal oxide include beryllium oxide, titanium oxide, zirconium oxide and zinc oxide in addition to the above-described alumina. Examples of the metal nitride include boron nitride, aluminum nitride and silicon nitride. Examples of the metal carbide include boron carbide, aluminum carbide and silicon carbide. A filler having a large average particle size and a filler having an average particle size smaller than the large average particle size are preferably used in combination, because the amount added (amount filled) of the filler can be increased.

In addition to the monofunctional (meth)acrylic monomer, a polyfunctional (meth)acrylic monomer is preferably included. By including a polyfunctional (meth)acrylic monomer, the polymer can be crosslinked and in turn, the strength of the sheet can be enhanced. Examples of the polyfunctional (meth)acrylic monomer include a diacrylate, a triacrylate, a tetraacrylate and a pentaacrylate. Examples of the diacrylate include 1,6-hexanediol diacrylate, 1,4-butanediol diacrylate, ethylene glycol diacrylate and diethylene glycol diacrylate. Examples of the triacrylate include trimethylolpropane triacrylate, trimethylolpropane trimethacrylate and pentaerythritol monohydroxy triacrylate. Examples of the tetraacrylate include pentaerythritol tetraacrylate and di-trimethylolpropane tetraacrylate. Examples of the pentaacrylate include dipentaerythritol (monohydroxy) pentaacrylate. The polyfunctional (meth)acrylic monomers may be used individually or in combination of two or more thereof. The amount of the polyfunctional (meth)acrylic monomer is usually from 0.05 to 1.5 parts by mass per 100 parts by mass of the monofunctional (meth)acrylic monomer.

### Other Additives, etc.

In the thermally conductive sheet of this embodiment, various additives can be added as long as the properties of the thermally conductive sheet are not impaired.

Specific examples of the additive include a tackifier, a crosslinking agent, a plasticizer, a flame retardant, an antioxidant, a flame retardant aid, an antisettling agent, a thickener, a thixotropy agent (e.g., ultrafine powder silica), a surfactant, an anti-foaming agent, a colorant, an electrically conducting particle, an antistatic agent, a metal inactivating agent, a filler dispersant (e.g., titanate), and a polymerization initiator other than those described above. These additives may be used individually or in combination of two or more thereof.

### EXAMPLES

The present invention is described below by referring to Examples, but the present invention is not limited to these Examples.

### Measurement of Ultraviolet Intensity:

In all of the following Examples and Comparative Examples, the cumulative intensity of ultraviolet radiation was measured by using UVIRAD™ (manufactured by EIT, Model Name: UR365CH3). Also, the cumulative intensities of ultraviolet radiation before and after transmission through the liner were measured by using the above-described apparatus and the ultraviolet transmittance of the liner was determined according to the following formula:

Ultraviolet transmittance (%)=cumulative intensity of ultraviolet radiation (after transmission)/cumulative intensity of ultraviolet radiation (before transmission)×100

### Example 1

The components according to the formulation shown in Table 1 below were charged en bloc into a planetary mixer and kneaded under reduced pressure (50 mmHg Abs.) for 15 minutes to obtain a thermally conductive sheet precursor composition. The obtained thermally conductive sheet precursor composition was sandwiched between two colorless transparent polyethylene terephthalate (PET) liners treated with a silicone release agent and having an ultraviolet transmittance of 98%, and calender-molded into a sheet. The obtained sheet still holding-liners on both surfaces thereof was irradiated with ultraviolet radiation for 15 minutes at an intensity of 0.13 mW/cm² on one surface and 0.52 mW/cm² on the other surface, whereby a 0.5 mm-thick single-layer thermally conductive sheet (Sheet 1) was obtained. Here, the surface irradiated with high-intensity ultraviolet radiation was designated as Surface A and the surface irradiated with low-intensity ultraviolet radiation was designated as Surface B.

### Example 2

The components according to the formulation shown in Table 1 below were charged en bloc into a planetary mixer and kneaded under reduced pressure (50 mmHg Abs.) for 15 minutes to obtain a thermally conductive sheet precursor composition. The obtained thermally conductive sheet precursor composition was sandwiched between two colorless transparent PET liners treated with a silicone release agent and having an ultraviolet transmittance of 98%, and calender-molded into a sheet. The obtained sheet still holding liners on both surfaces thereof was irradiated with ultraviolet radiation for 15 minutes at an intensity of 0.31 mW/cm² on one surface and 0.72 mW/cm² on the other surface, whereby a 0.5 mm-thick single-layer thermally conductive sheet (Sheet 2) was obtained. Here, the surface irradiated with high-intensity ultraviolet radiation was designated as Surface A and the surface irradiated with low-intensity ultraviolet radiation was designated as Surface B.

### Example 3

The components according to the formulation shown in Table 1 below were charged en bloc into a planetary mixer and kneaded under reduced pressure (50 mmHg Abs.) for 15 minutes to obtain a thermally conductive sheet precursor composition. The obtained thermally conductive sheet precursor composition was sandwiched between two colorless transparent polyethylene terephthalate (PET) liners treated with a silicone release agent and having an ultraviolet transmittance of 98%, and calender-molded into a sheet. The obtained sheet still holding liners on both surfaces thereof was irradiated with ultraviolet radiation for 15 minutes at an intensity of 0.05 mW/cm² on one surface and 0.80 mW/cm² on the other surface, whereby a 0.5 mm-thick single-layer thermally conductive sheet (Sheet 3) was obtained. Here, the surface irradiated with high-intensity ultraviolet radiation was designated as Surface A and the surface irradiated with low-intensity ultraviolet radiation was designated as Surface B.

### Example 4

The components according to the formulation shown in Table 1 below were charged en bloc into a planetary mixer and kneaded under reduced pressure (50 mmHg Abs.) for 15 minutes to obtain a thermally conductive sheet precursor composition. The obtained thermally conductive sheet precursor composition was sandwiched between two colorless transparent polyethylene terephthalate (PET) liners treated with a silicone release agent and having an ultraviolet transmittance of 98%, and calender-molded into a sheet. The obtained sheet still holding liners on both surfaces thereof was irradiated with ultraviolet radiation for 15 minutes at an intensity of 0.05 mW/cm² on one surface and 0.33 mW/cm² on the other surface, whereby a 0.5 mm-thick single-layer thermally conductive sheet (Sheet 4) was obtained. Here, the surface irradiated with high-intensity ultraviolet radiation was designated as Surface A and the surface irradiated with low-intensity ultraviolet radiation was designated as Surface B.

### Example 5

The components according to the formulation shown in Table 1 below were charged en bloc into a planetary mixer and kneaded under reduced pressure (50 mmHg Abs.) for 15 minutes to obtain a thermally conductive sheet precursor composition. The obtained thermally conductive sheet precursor composition was sandwiched between two colorless transparent polyethylene terephthalate (PET) liners treated with a silicone release agent and having an ultraviolet transmittance of 98%, and calender-molded into a sheet. The obtained sheet still holding liners on both surfaces thereof was irradiated with ultraviolet radiation for 15 minutes at an intensity of 0.05 mW/cm² on one surface and 0.32 mW/cm² on the other surface, whereby a 0.5 mm-thick single-layer thermally conductive sheet (Sheet 5) was obtained. Here, the surface irradiated with high-intensity ultraviolet radiation was designated as Surface A and the surface irradiated with low-intensity ultraviolet radiation was designated as Surface B.

### Comparative Example 1

A 0.5 mm-thick single-layer thermally conductive sheet (Sheet 6) was obtained in the same manner as in Example 1 except that, as shown in Table 1 below, the formulation was different.

### Comparative Example 2

The components according to the formulation shown in Table 1 below were charged en bloc into a planetary mixer and kneaded under reduced pressure (50 mmHg Abs.) for 15 minutes to obtain a thermally conductive sheet precursor composition. The obtained thermally conductive sheet precursor composition was sandwiched between two colorless transparent polyethylene terephthalate (PET) liners treated with a silicone release agent and having an ultraviolet transmittance of 98%, and calender-molded into a sheet. The obtained sheet still holding liners on both surfaces thereof was irradiated with ultraviolet radiation for 15 minutes at an intensity of 0.03 mW/cm² on one surface and 0.98 mW/cm² on the other surface, whereby a 1.0 mm-thick single-layer thermally conductive sheet (Sheet 7) was obtained. Here, the surface irradiated with high-intensity ultraviolet radiation was designated as Surface A and the surface irradiated with low-intensity ultraviolet radiation was designated as Surface B.

### Comparative Example 3

The components according to the formulation shown in Table 1 below were charged en bloc into a planetary mixer and kneaded under reduced pressure (50 mmHg Abs.) for 15 minutes to obtain a thermally conductive sheet precursor composition. The obtained thermally conductive sheet precursor composition was sandwiched between two colorless transparent polyethylene terephthalate (PET) liners treated with a silicone release agent and having an ultraviolet transmittance of 98%, and calender-molded into a sheet. The obtained sheet still holding liners on both surfaces thereof was irradiated with ultraviolet radiation for 15 minutes at an intensity of 0.52 mW/cm² on both surfaces, whereby a 0.5 mm-thick single-layer thermally conductive sheet (Sheet 8) was obtained. Here, for the sake of convenience, one arbitrary surface was designated as Surface A and the other surface was designated as Surface B.

TABLE 1
Blending Formulation

| | | Composition (parts by mass) | | | | | | | |
|---|---|---|---|---|---|---|---|---|---|
| | | | | | | | Comparative | Comparative | Comparative |
| Component | | Example 1 | Example 2 | Example 3 | Example 4 | Example 5 | Example 1 | Example 2 | Example 3 |
| Binder | 2-Ethylhexyl acrylate (acrylic | 100 | 100 | 100 | 100 | 100 | 100 | 100 | 100 |
| Part | monomer) | | | | | | | | |
| | 1,6-Hexanediol diacrylate | 0.15 | 0.22 | 0.22 | 0.25 | 0.33 | 0.40 | 0.15 | 0.22 |
| | (crosslinking agent) | | | | | | | | |
| | Tetraethylene glycol-di-2- | 10 | 10 | 10 | 2 | — | — | 10 | 10 |
| | ethylhexonate (plasticizer) | | | | | | | | |
| | Irganox 1076*¹ (phenol-based | 0.50 | 0.50 | 0.50 | 0.50 | 0.50 | 0.50 | 0.50 | 0.50 |
| | antioxidant) | | | | | | | | |
| | Irgacure 651*² (photo-initiator) | 0.40 | 0.40 | 0.40 | 0.40 | 0.40 | 0.40 | 0.40 | 0.40 |
| | Titacoat S-151*³ (titanate-based | 5.0 | 3.0 | 3.0 | 1 | — | — | 5.0 | 3.0 |
| | coupling agent) | | | | | | | | |
| Filler | H34*⁴ (aluminum hydroxide) | 750 | 480 | 480 | 200 | 70 | 5.0 | 750 | 480 |
| Part | | | | | | | | | |

*¹Trade name (produced by Ciba Specialty-Chemicals)
*²Trade name (produced by Ciba Specialty-Chemicals)
*³Trade name (produced by Nippon Soda Co., Ltd.)
*⁴Trade name (produced by Showa Denko K.K.)

The thermally conductive filler contents in Examples and Comparative Examples are shown in Table 2 below.

TABLE 2
Content* (vol %) of Thermally Conductive Filler in Sheet

| | | | | | | Comparative | | |
|---|---|---|---|---|---|---|---|---|
| | Example | | | | | Example | | |
| | 1 | 2 | 3 | 4 | 5 | 1 | 2 | 3 |
| H34 (aluminum | 72.9 | 63.5 | 63.5 | 44.5 | 21.9 | 2.0 | 72.9 | 63.5 |
| hydroxide) | | | | | | | | |

*The specific gravity of the binder part was set to 1.0 g/cm³, and the specific gravity of aluminum hydroxide was set to 2.4 g/cm³.

### Measuring Method:

The thermally conductive sheets produced above were evaluated for the adhesion energy on both surfaces (Surface A, Surface B) of the sheet by the following method. At the evaluation, the sheet was used for evaluation after stripping the liners from both surfaces thereof.

### Adhesion Energy:

The tackiness of both surfaces of the sheet was evaluated in terms of the adhesion energy by using Probe Tack Tester RPT1000 (manufactured by RHESCA). Here, the adhesion energy was determined from the area of the stress-strain curve obtained by the measurement. As the adhesion energy is larger, the tackiness is larger. The measuring conditions are as follows.

Load: 500 g

Press-contact time: 1.0 second

Testing speed: 600 mm/min.

Stainless steel-made probe (diameter: 5 mm)

The adhesion energy is shown as an average of the number of measurements (n=5).

The measurement results of UV irradiation intensity and adhesion energy are shown in Tables 3 and 4 below.

TABLE 3
UV Irradiation Intensity (mW/cm²)

| | Surface A | Surface B | Surface A/Surface B¹⁾ |
|---|---|---|---|
| Example 1 | 0.52 | 0.13 | 4.0 |
| Example 2 | 0.72 | 0.31 | 2.3 |
| Example 3 | 0.80 | 0.05 | 16.0 |
| Example 4 | 0.33 | 0.05 | 6.6 |
| Example 5 | 0.32 | 0.05 | 6.4 |
| Comparative Example 1 | 0.52 | 0.13 | 4.0 |
| Comparative Example 2 | 0.98 | 0.03 | 32.7 |
| Comparative Example 3 | 0.52 | 0.52 | 1.0 |

¹⁾Ratio of UV irradiation intensity on Surface A to that on Surface B

TABLE 4
Adhesive Energy (mJ) of Thermally Conductive Sheet

| | Surface A | Surface B | Surface A/Surface B¹⁾ |
|---|---|---|---|
| Example 1 | 1.00 | 0.07 | 14.3 |
| Example 2 | 2.62 | 0.19 | 13.8 |
| Example 3 | 3.41 | 0.23 | 14.8 |
| Example 4 | 3.92 | 0.58 | 6.8 |
| Example 5 | 4.47 | 0.73 | 6.1 |
| Comparative Example 1 | 3.10 | 3.02 | 1.0 |
| Comparative Example 2 | 3.62 | 0.11 | 32.9 |
| Comparative Example 3 | 3.02 | 3.15 | 0.96 |

¹⁾Ratio of adhesion energy on Surface A to that on Surface B

In the case of the thermally conductive sheets according to the present invention of Examples 1 to 5, a thermally conductive sheet having tack strength differing between one surface and the other surface could be obtained by irradiating ultraviolet radiation at different intensities. On the other hand, in the sheet of Comparative Example 1, the amount of the thermally conductive filler was as low as 2.0 vol % and therefore, almost no difference was yielded in the tackiness of both surfaces of the sheet obtained. In Comparative Example 2, the ultraviolet radiation was irradiated at an irradiation intensity ratio exceeding 30 times while employing a certain high filler content and therefore, the filler migrated to Surface B of the sheet. The migration of filler to one surface of the thermally conductive sheet is not preferred because the filler may desorb from the sheet to cause contamination in the production process or stain the adherend of the sheet. In Comparative Example 3, the irradiation intensity was the same on both surfaces and accordingly, almost no difference was yielded in the tackiness of both surfaces.

1-6. (canceled)

7. A method for producing a thermally conductive sheet, comprising:
(a) shaping a thermally conductive composition precursor into a sheet having a front surface and a back surface, the thermally conductive composition precursor comprising a (meth)acrylic monomer or a polymerizable oligomer thereof, a photopolymerization initiator, and a thermally conductive filler present in an amount of 20 vol % or more based on the total volume of the thermally conductive composition obtained, and
(b) irradiating the front surface and the back surface of the sheet with ultraviolet radiation of different ultraviolet irradiation intensities such that the irradiation intensity on the surface irradiated at a higher intensity is 30 times, or less, than the irradiation intensity on the surface irradiated at a lower intensity, thereby curing the sheet and obtaining a thermally conductive sheet having a single-layer thermally conductive composition and having tackiness differing between the front surface and the back surface.

8. The method for producing a thermally conductive sheet as claimed in claim 7, wherein the (meth)acrylic monomer or the polymerizable oligomer thereof is a polymerizable oligomer obtained by partially polymerizing a (meth)acrylic monomer and thereby increasing the viscosity of the (meth)acrylic monomer.

9. The method for producing a thermally conductive sheet as claimed in claim 7, wherein said thermally conductive filler is a filler selected from aluminum hydroxide, magnesium hydroxide and alumina (aluminum oxide).

10. The method for producing a thermally conductive sheet as claimed in claim 8, wherein said thermally conductive filler is a filler selected from aluminum hydroxide, magnesium hydroxide and alumina (aluminum oxide).

11. The method for producing a thermally conductive sheet as claimed in. 7, wherein the ultraviolet irradiation intensity on the surface irradiated at a higher intensity is from 2 to 20 times the irradiation intensity on the surface irradiated at a lower intensity.

12. The method for producing a thermally conductive sheet as claimed in claim 8, wherein the ultraviolet irradiation intensity on the surface irradiated at a higher intensity is from 2 to 20 times the irradiation intensity on the surface irradiated at a lower intensity.

13. The method for producing a thermally conductive sheet as claimed in claim 9, wherein the ultraviolet irradiation intensity on the surface irradiated at a higher intensity is from 2 to 20 times the irradiation intensity on the surface irradiated at a lower intensity.

14. The method for producing a thermally conductive sheet as claimed in claim 7, wherein the ultraviolet irradiation intensity is 0.2 to 1.5 mW/cm² on the side irradiated at a higher intensity.

15. The method for producing a thermally conductive sheet as claimed in claim 8, wherein the ultraviolet irradiation intensity is 0.2 to 1.5 mW/cm² on the side irradiated at a higher intensity.

16. The method for producing a thermally conductive sheet as claimed in claim 9, wherein the ultraviolet irradiation intensity is 0.2 to 1.5 mW/cm² on the side irradiated at a higher intensity.

17. The method for producing a thermally conductive sheet as claimed in claim 11, wherein the ultraviolet irradiation intensity is 0.2 to 1.5 mW/cm² on the side irradiated at a higher intensity.

18. A thermally conductive sheet produced by the production method of a thermally conductive sheet claimed in claim 7.

19. A thermally conductive sheet produced by the production method of a thermally conductive sheet claimed in claim 11.

20. A thermally conductive sheet produced by the production method of a thermally conductive sheet claimed in claim 14.
